(19) United States
(12) Patent Application Publication
(10) Pub. No.: US 2015/0371235 A1
(43) Pub. Date: Dec. 24, 2015

(54) Mobile Payment System and Mobile Payment Method based on Biometric Authentication

(71) Applicant: GOLDEN VAST MACAO COMMERCIAL OFFSHORE LIMITED

(72) Inventor: KwokFong WONG, HongKong (CN)

(21) Appl. No.: 14/738,074

(22) Filed: Jun. 12, 2015

(30) Foreign Application Priority Data
Jun. 18, 2014 (CN) 201410274432.1

(51) Int. Cl. G06Q 20/40; G06Q 20/32; G06Q 20/38

(52) U.S. Cl. CPC G06Q 20/40145; G06Q 20/3829; G06Q 20/3226

(57) ABSTRACT

The invention discloses a mobile payment system and mobile payment method based on biometric authentication. The mobile payment system comprises a mobile terminal, an identification code provided on a menu, a system server and a mobile payment platform. The mobile payment method comprises: scanning at least one identification code respectively corresponding to at lest one object on the menu by a mobile terminal to form a list, and sending the list and a number corresponding to the mobile terminal to the system server; sending the list to the mobile payment platform by a system server, and sending a payment instruction to the mobile payment platform to request a user of the mobile terminal to pay; sending the list to the mobile terminal after receiving the payment instruction by the mobile payment platform, and sending a confirmation message back to the mobile payment platform after the user confirming by the mobile terminal and paying biometrically; and sending an instruction of payment completion to the system server by the mobile payment platform. By means of the invention, waiting is not needed for ordering such that transactions can be achieved instantaneously, this greatly improves the security and efficiency.

### FIELD OF THE INVENTION

The invention relates to the filed of electronic technique, and more particularly to a mobile payment system and a mobile payment method based on biometric authentication.

### DESCRIPTION OF THE RELATED ART

Currently, in people's daily life, transaction behaviors between consumers and business operators occur everywhere. However, with the gradually frequent happening of transactions, it is found that there exist the following disadvantages during ordering of the consumers: 1, for the consumers, a lot of time is wasted due to the long waiting; 2. for the business operators, it is needed to employ a staff to solve the problems issued by the consumers, thereby increasing the cost of time and money; 3. for the business operators, cash is managed by an engaged staff, and this increase the risk.

### SUMMARY OF THE INVENTION

In order to solve the above technical problem of the prior art, the embodiments of the invention provide a mobile payment system and a mobile payment method based on biometric authentication.

The invention utilizes the following technical solutions.

In one aspect, the invention provides a mobile payment system based on biometric authentication, the system comprises a mobile terminal, an identification code provided on a menu, a system server and a mobile payment platform, each object on the menu corresponds to an identification code.

The mobile terminal is used for scanning at least one identification code respectively corresponding to at lest one object on the menu to form a list, and sending the list and a number corresponding to the mobile terminal to the system server.

The system server is used for sending the list to the mobile payment platform, and sending a payment instruction to the mobile payment platform to request a user of the mobile terminal to pay.

The mobile payment platform is used for sending the list to the mobile terminal after receiving the payment instruction, and sending a confirmation message back to the mobile payment platform after the user confirming by means of the mobile terminal and paying biometrically.

The mobile payment platform also is used for sending an instruction of payment completion to the system server, thereby sending down a trading instruction by the system server.

In another aspect, the invention provides a mobile payment method based on biometric authentication, the method comprise the steps of:
scanning at least one identification code respectively corresponding to at lest one object on the menu by a mobile terminal to form a list, and sending the list and a number corresponding to the mobile terminal to the system server, wherein each object on the menu corresponds to an identification code;
sending the list to the mobile payment platform by a system server, and sending a payment instruction to the mobile payment platform to request a user of the mobile terminal to pay;
sending the list to the mobile terminal after receiving the payment instruction by the mobile payment platform, and sending a confirmation message back to the mobile payment platform after the user confirming by the mobile terminal and paying biometrically; and
sending an instruction of payment completion to the system server by the mobile payment platform, thereby sending down a trading instruction by the system server.

The invention has the following advantages by utilizing the technical solutions of the embodiments:

The mobile terminal scans at least one identification code respectively corresponding to at least one object on the menu to form a list, such that waiting is not needed for ordering. Payment is achieved by means of the mobile payment platform, and this will lead to instantaneous transactions. Confirming by means of the mobile terminal and paying biometrically avoid illegal payment of others, thereby ensuring the security and efficiency of transactions.

### BRIEF DESCRIPTION OF THE DRAWINGS

In order to illustrate more clearly the technical solutions of the embodiments of the invention, the drawings used in the embodiments will be described simply hereinafter. Obviously, the drawings are given by way of example, and for a person skilled in the art, other equivalent drawings can be obtained according to these drawings without any creative work.

FIG. 1 is a schematic drawing of a mobile payment system based on biometric authentication according to embodiment 1 of the invention;

FIG. 2 is a flow chart of a mobile payment method based on biometric authentication according to embodiment 2 of the invention.

### DETAILED DESCRIPTION OF THE INVENTION

In order to make the object, technical solutions and advantages of the invention more clearly, the embodiments will be described hereinafter in more detail in connection with drawings.

### Embodiment 1

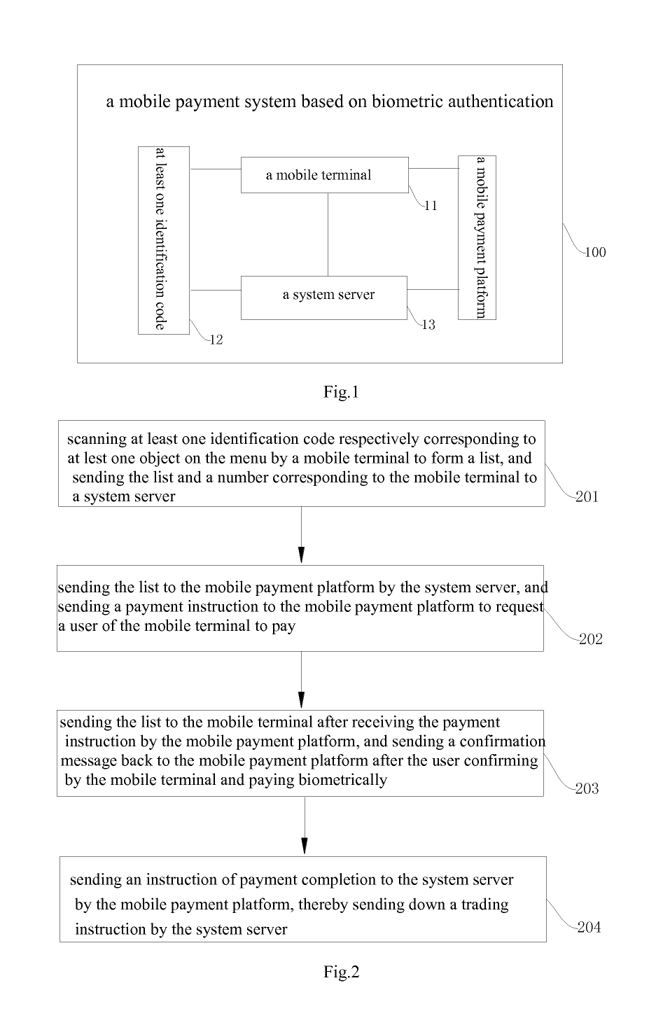

FIG. 1 is a schematic drawing of a mobile payment system based on biometric authentication according to embodiment 1 of the invention. As shown in FIG. 1, the mobile payment system 100 based on biometric authentication provided by this embodiment of the invention comprises a mobile terminal 11, multiple identification codes 12 provided on a menu, a system server 13 and a mobile payment platform 4. Each object on the menu corresponds an identification code 12.

Wherein the mobile terminal 11 is used for scanning at least one identification code 12 respectively corresponding to at lest one object on the menu to form a list, and sending the list and the number corresponding to the mobile terminal 11 to the system server 13. The system server 13 is used for sending the list to the mobile payment platform 14, and sending a payment instruction to the mobile payment platform 14 to request a user of the mobile terminal 11 to pay. The mobile payment platform 14 is used for sending the list to the mobile terminal 11 after receiving the payment instruction, and sending a confirmation message back to the mobile payment platform 14 after the user confirming by the mobile terminal and paying biometrically. The mobile payment platform 14 is also used for sending an instruction of payment completion to the system server 13, thereby sending down a trading instruction by means of the system server 13.

In the mobile payment system based on biometric authentication provided by this embodiment of the invention, the mobile terminal 11 scans at least one identification code 12 respectively corresponding to at least one object on the menu to form a list, such that waiting is not needed for ordering. Payment is achieved by means of the mobile payment platform 14, and this will lead to instantaneous transactions. Confirming by means of the mobile terminal 11 and paying biometrically avoid illegal payment of others, thereby ensuring the security and efficiency of transactions. Preferably, in the above embodiment 1, the identification code 12 also sends a first public key to the mobile terminal 11, such that the mobile terminal 11 encrypts the list and the number of the mobile terminal 11 by means of the first public key, and sends the encrypted list and number to the system server 13. Correspondingly, the system server 13 decrypts the list and the number of the mobile terminal 11 using a first private key after receiving the encrypted list and number of the mobile terminal 11. The first public key and the first private key are generated by providing the first biological information of an operator.

Preferably, in the above embodiment 1, after receiving the payment instruction from the system server 13, the mobile payment platform 14 encrypts the list through its own protocol and sends the list to the mobile terminal 11. The mobile terminal 11 confirms by extracting the second biological information of the user, and encrypts the confirmation message of the user utilizing a second private key generated by the second biological information, and sends it to the mobile payment platform 14. The mobile payment platform 14 decrypts by utilizing a second public key generated by the second biological information to complete payment of an order.

Preferably, in the above embodiment 1, the mobile terminal 11 is also used for sending the second public key to the mobile payment platform 14, the second private key is stored a biological information device of the mobile terminal 11.

By means of the above payment means, it can be seen that, the embodiment 1 of the invention utilizes two sets of keys: first keys (a first public key and a first private key) which can be extracted and generated by the biological information device on the system server 13; second keys (a second public key and a second private key) which can be extracted and generated by a biological information device on the mobile terminal 11. The second public key is sent to the mobile payment platform 14 by the mobile terminal 11, and the second private key is stored on the biological information device of the first terminal 11. Furthermore, the encryption and decryption of the embodiment 1 of the invention is not limited to any of the two set of keys, and encryption and decryption can be achieved provided that the two keys can matched with each other.

Preferably, in the above embodiment 1, the mobile payment platform 14 may specifically be an electronic payment platform provided by a business operator, and a payment bill is shown in a telephone bill of the mobile terminal. Or alternatively, the mobile payment platform 14 may be a bank authorized payment system. A person skilled in the art shall appreciate that, in the embodiment of the invention, the electronic payment platform or bank authorized payment system is illustrated by way of example, and the embodiment of the invention is not limited to the two ways.

### Embodiment 2

FIG. 2 is a flow chart of a mobile payment method based on biometric authentication according to embodiment 2 of the invention. This embodiment can be implemented by the mobile payment system based on biometric authentication of the embodiment 1. As shown in FIG. 2, the mobile payment method based on biometric authentication of the embodiment 2 of the invention comprises:

Step 201: scanning at least one identification code respectively corresponding to at lest one object on the menu by a mobile terminal to form a list, and sending the list and a number corresponding to the mobile terminal to a system server, wherein each object on the menu corresponds to an identification code;

Step 202: sending the list to the mobile payment platform by the system server, and sending a payment instruction to the mobile payment platform to request a user of the mobile terminal to pay;

Step 203: sending the list to the mobile terminal after receiving the payment instruction by the mobile payment platform, and sending a confirmation message back to the mobile payment platform after the user confirming by the mobile terminal and paying biometrically;

Step 204: sending an instruction of payment completion to the system server by the mobile payment platform, thereby sending down a trading instruction by the system server.

In the mobile payment method based on biometric authentication provided by the embodiment 2 of the invention, the mobile terminal scans at least one identification code respectively corresponding to at least one object on the menu to form a list, such that waiting is no needed for ordering. Payment is achieved by means of the mobile payment platform, and this will lead to instantaneous transactions. Confirming by means of the mobile terminal and paying biometrically avoid illegal payment of others, thereby ensuring the security and efficiency of transactions.

Preferably, in the above embodiment 2, the mobile payment method also comprises:
the identification code also sending a first public key to the mobile terminal, the mobile terminal encrypting the list and the number of the mobile terminal by means of the first public key, and sending the encrypted list and number to the system server; and
correspondingly, the system server decrypting the list and the number of the mobile terminal using a first private key after receiving the encrypted list and number of the mobile terminal;
and wherein the first public key and the first private key are generated by providing first biological information of an operator.

Preferably, in the above embodiment 2, the mobile payment method also comprises:
after receiving the payment instruction from the system server, the mobile payment platform encrypting the list through its own protocol and sending the list to the mobile terminal;
the mobile terminal confirming by extracting the second biological information of the user, and encrypting the confirmation message of the user utilizing a second private key generated by the second biological information, and sending it to the mobile payment platform; and
the mobile payment platform performing decryption by utilizing a second public key generated by the second biological information to complete payment of order.

Preferably, in the above embodiment 2, the mobile payment method also comprises:
sending the second public key to the mobile payment platform by the mobile terminal, the second private key being stored a biological information device of the mobile terminal.

By means of the above payment means, it can be seen that, the embodiment 2 of the invention utilizes two sets of keys: first keys (a first public key and a first private key) which can be extracted and generated by the biological information device on the system server 13; second keys (a second public key and a second private key) which can be extracted and generated by a biological information device on the mobile terminal 11. The second public key is sent to the mobile payment platform 14 by the mobile terminal 11, and the second private key is stored on the biological information device of the first terminal 11. Furthermore, the encryption and decryption of the embodiment 1 of the invention is not limited to any of the two sets of keys, and encryption and decryption can be achieved provided that the two keys can matched with each other.

Preferably, in the above embodiment 2, the mobile payment platform may specifically be an electronic payment platform provided by a business operator, and a payment bill is shown in a telephone bill of the mobile terminal. Or alternatively, the mobile payment platform may be a bank authorized payment system. A person skilled in the art shall appreciate that, in the embodiment of the invention, the electronic payment platform or bank authorized payment system is illustrated by way of example, and the embodiment of the invention is not limited to the two ways.

Preferably, in the above embodiments 1 and 2, the object can specifically be a dish on a menu provided to consumers by a restaurant. The list may specifically be a dish list ordered by a consumer. The operator is a restaurant operator, and the system server is a restaurant system server. A person skilled in the art can appreciate that, the restaurant is illustrated by way of example, and will not be considered as limitation of the embodiments of the invention.

The numberings of the embodiments are given only for description, instead of representing the quality of the embodiments.

A person skilled in the art shall appreciate that, part or all of the steps achieving the above embodiments can be completed by means of hardware, or by instructing related hardware via a program, and the program may be stored in a computer-readable storage medium which may be a read only memory, magnetic disk or optical disc or the like.

The preferred embodiments as above described are not intended for limiting of the invention, any variations, equivalent substitutions, improvement within the spirit and scope of the invention are contained in the extent of protection of the invention.

1. A mobile payment system based on biometric authentication, comprising a mobile terminal, an identification code provided on a menu, a system server and a mobile payment platform, each object on the menu corresponding to an identification code, wherein:
the mobile terminal is used for scanning at least one identification code respectively corresponding to at least one object on the menu to form a list, and sending the list and a number corresponding to the mobile terminal to the system server;
the system server being used for sending the list to the mobile payment platform, and sending a payment instruction to the mobile payment platform to request a user of the mobile terminal to pay ;
the mobile payment platform being used for sending the list to the mobile terminal after receiving the payment instruction, and sending a confirmation message back to the mobile payment platform after the user confirming by means of the mobile terminal and paying biometrically; and
the mobile payment platform also being used for sending an instruction of payment completion to the system server, thereby sending down a trading instruction by the system server.

2. The mobile payment system as claimed in claim 1, wherein:
the identification code also sends a first public key to the mobile terminal, such that the mobile terminal encrypts the list and the number of the mobile terminal by means of the first public key, and sends the encrypted list and number to the system server; correspondingly
the system server decrypts the list and the number of the mobile terminal using a first private key after receiving the encrypted list and number of the mobile terminal;
and wherein the first public key and the first private key are generated by providing the first biological information of an operator.

3. The mobile payment system as claimed in claim 1, wherein:
after receiving the payment instruction from the system server, the mobile payment platform encrypts the list through its own protocol and sends the list to the mobile terminal;
the mobile terminal confirming by extracting the second biological information of the user, and encrypting the confirmation message of the user utilizing a second private key generated by the second biological information, and sending it to the mobile payment platform;
the mobile payment platform performing decryption by utilizing a second public key generated by the second biological information to complete payment of an order.

4. The mobile payment system as claimed in claim 3, wherein:
the mobile terminal also is used for sending the second public key to the mobile payment platform, the second private key being stored a biological information device of the mobile terminal.

5. The mobile payment system as claimed in claim 1, wherein
the mobile payment platform is an electronic payment platform provided by an operator, and a payment bill is shown in a telephone bill of the mobile terminal; or
the mobile payment platform is a bank authorized payment system.

6. A mobile payment method based on biometric authentication, comprising:
scanning at least one identification code respectively corresponding to at least one object on the menu by a mobile terminal to form a list, and sending the list and a number corresponding to the mobile terminal to the system server, wherein each object on the menu corresponds to an identification code;
sending the list to the mobile payment platform by a system server, and sending a payment instruction to the mobile payment platform to request a user of the mobile terminal to pay;
sending the list to the mobile terminal after receiving the payment instruction by the mobile payment platform, and sending a confirmation message back to the mobile payment platform after the user confirming by the mobile terminal and paying biometrically; and
sending an instruction of payment completion to the system server by the mobile payment platform, thereby sending down a trading instruction by the system server.

7. The mobile payment method as claimed in claim 6, wherein the method also comprises:
the identification code also sending a first public key to the mobile terminal, the mobile terminal encrypting the list and the number of the mobile terminal by means of the first public key, and sending the encrypted list and number to the system server;
correspondingly, the system server decrypting the list and the number of the mobile terminal using a first private key after receiving the encrypted list and number of the mobile terminal;
and wherein the first public key and the first private key are generated by providing the first biological information of an operator.

8. The mobile payment method as claimed in claim 6, wherein the method also comprises:
after receiving the payment instruction from the system server, the mobile payment platform encrypting the list through its own protocol and sending the list to the mobile terminal;
the mobile terminal confirming by extracting the second biological information of the user, and encrypting the confirmation message of the user utilizing a second private key generated by the second biological information, and sending it to the mobile payment platform;
the mobile payment platform performing decryption by utilizing a second public key generated by the second biological information to complete payment of an order.

9. The mobile payment method as claimed in claim 8, wherein the method also comprises:
sending the second public key to the mobile payment platform by the mobile terminal, and the second private key being stored a biological information device of the mobile terminal.

10. The mobile payment method as claimed in claim 6, wherein
the mobile payment platform is an electronic payment platform provided by an operator, and a payment bill is shown in a telephone bill of the mobile terminal; or
the mobile payment platform is a bank authorized payment system.

11. The mobile payment system as claimed in claim 2, wherein
the mobile payment platform is an electronic payment platform provided by an operator, and a payment bill is shown in a telephone bill of the mobile terminal; or
the mobile payment platform is a bank authorized payment system.

12. The mobile payment system as claimed in claim 3, wherein
the mobile payment platform is an electronic payment platform provided by an operator, and a payment bill is shown in a telephone bill of the mobile terminal; or
the mobile payment platform is a bank authorized payment system.

13. The mobile payment system as claimed in claim 4, wherein
the mobile payment platform is an electronic payment platform provided by an operator, and a payment bill is shown in a telephone bill of the mobile terminal; or
the mobile payment platform is a bank authorized payment system.

14. The mobile payment method as claimed in claim 7, wherein
the mobile payment platform is an electronic payment platform provided by an operator, and a payment bill is shown in a telephone bill of the mobile terminal; or
the mobile payment platform is a bank authorized payment system.

15. The mobile payment method as claimed in claim 8, wherein
the mobile payment platform is an electronic payment platform provided by an operator, and a payment bill is shown in a telephone bill of the mobile terminal; or
the mobile payment platform is a bank authorized payment system.

16. The mobile payment method as claimed in claim 9, wherein
the mobile payment platform is an electronic payment platform provided by an operator, and a payment bill is shown in a telephone bill of the mobile terminal; or
the mobile payment platform is a bank authorized payment system.
